(19) United States
(12) Patent Application Publication
(10) Pub. No.: US 2011/0310020 A1
(43) Pub. Date: Dec. 22, 2011

(54) TOUCH-TYPE TRANSPARENT KEYBOARD

(75) Inventors: KUN-TSAN WU, Shindian (TW); LI-WEN TIEN, Shindian (TW)

(73) Assignee: FIH (HONG KONG) LIMITED, Kowloon (HK)

(21) Appl. No.: 12/948,866

(22) Filed: Nov. 18, 2010

(30) Foreign Application Priority Data
Jun. 18, 2010 (CN) 201010203304.X

(51) Int. Cl. G06F 3/02; G06F 3/041

(52) U.S. Cl. 345/168; 345/173

(57) ABSTRACT

A touch-type transparent keyboard includes a transparent substrate, a keyboard layer, a first insulation layer, a shield layer, a second insulation layer, a position detection layer, a transparent protective layer, and a control module. The keyboard layer and the control module are located on the transparent substrate. The first insulation layer is attached to the keyboard layer. The shield layer is located between the first insulation layer and the second insulation layer. The position detection layer is located between the second insulation layer and the protective layer. The keyboard layer, the shield layer and the position detection layer are electronically connected to the control module.

### BACKGROUND

1. Technical Field

The present disclosure generally relates to touch-type keyboards, and particularly to a touch-type transparent keyboard for use with an electronic device.

2. Description of Related Art

A keyboard is a user interface for inputting characters for operating electronic devices. Touch-type keyboards are thinner, lighter and are becoming more widely used. Currently, the touch-type keyboard includes a touch screen and a support substrate beneath the touch screen. The support substrate provides key icons and increases the thickness of the touch-type keyboard.

Therefore, there is room for improvement within the art.

### BRIEF DESCRIPTION OF THE DRAWINGS

Many aspects of the present touch-type transparent keyboard can be better understood with reference to the following drawings. The components in the drawings are not necessarily to scale, the emphasis instead being placed upon clearly illustrating the touch-type transparent keyboard. Moreover, in the drawings, like reference numerals designate corresponding parts throughout the several views.

FIG. 1 is a cross sectional view of a touch-type transparent keyboard according to a first embodiment of the present disclosure.

FIG. 2 is a schematic view of a keyboard layer shown in FIG. 1.

FIG. 3 is a schematic view of the touch-type transparent keyboard shown in FIG. 1.

FIG. 4 is a cross sectional view of a touch-type transparent keyboard according to a second embodiment of the present disclosure.

### DETAILED DESCRIPTION

Reference is now made to the drawings to describe various embodiments of the present disclosure in detail. The present disclosure provides a touch-type transparent keyboard which is a touch screen with a built-in keyboard layer.

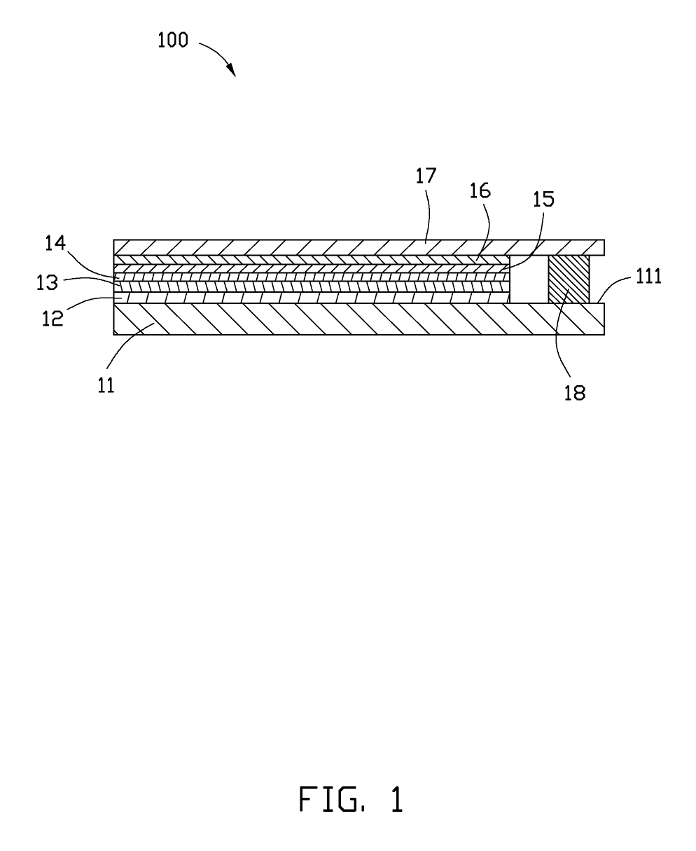

Referring to FIG. 1, a touch-type transparent keyboard 100, according to a first embodiment of the present disclosure, includes a transparent substrate 11, a transparent keyboard layer 12, a first insulation layer 13, a shield layer 14, a second insulation layer 15, a position detection layer 16, a transparent protective layer 17, and a control module 18. The keyboard layer 12 is located on the transparent substrate 11. The first insulation layer 13 is attached to the keyboard layer 12. The shield layer 14 is located between the first insulation layer 13 and the second insulation layer 15. The position detection layer 16 is located between the second insulation layer 15 and the protective layer 17. The transparent substrate 11 includes an extension portion 111. The control module 18 is located on the extension portion 111. The control module 18 includes a ground terminal (not shown). The keyboard layer 12 and the position detection layer 16 are electronically connected to the control module 18. The shield layer 14 is electronically connected to the ground terminal.

The first insulation layer 13, and the second insulation layer 15 are made of transparent insulation materials, such as silicon dioxide (SiO) or polyethylene terephthalate (PET). The first insulation layer 13 separates the keyboard layer 12 and the shield layer 14. The second insulation layer 15 separates the shield layer 14 and the position detection layer 16. The shield layer 14 is made of transparent conductive materials, such as indium tin oxide (ITO), aluminum-doped zinc oxide, or cadmium oxide (CdO). The shield layer 14 prevents signal interference between the keyboard layer 12 and the position detection layer 16. The position detection layer 16 detects touch locations, in an exemplary embodiment, the position detection layer 16 is a capacitive layer and made of transparent conductive materials, such as ITO, aluminum-doped zinc oxide, or CdO.

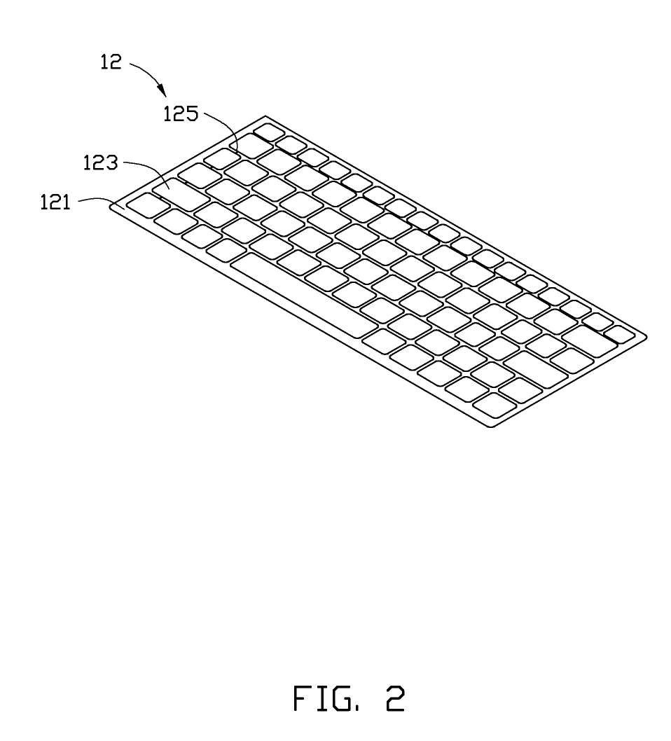

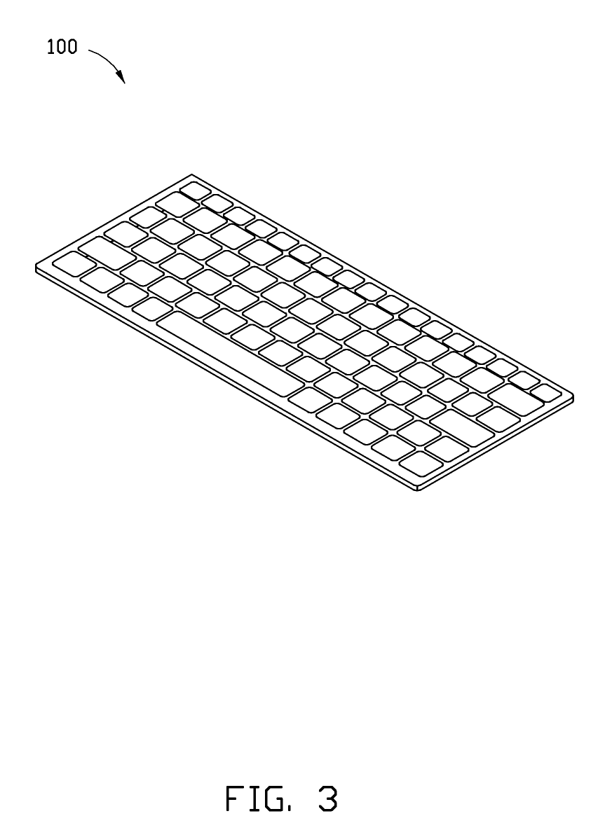

Referring to FIG. 2, the keyboard layer 12 includes a transparent film 121, a number of key icons 123, and a drive circuit 125. The key icons 123 and the drive circuit 125 are located on the film 121. The film 121 can be made of polyester or polyamide. The key icons 123 are made of transparent electroluminescence material, and can illuminate when the touch-type transparent keyboard 100 is powered on. The drive circuit 125 may be made of transparent conducting material and printed on the film 121. The drive circuit 125 is electrically connected to the key icons 123 and the control module 18. Coordinate information of the key icons 123 is stored in the control module 18 corresponding to touch positions on the protective layer 17. When the drive circuit 125 is powered on, the key icons 123 illuminate and can be seen by users; when the drive circuit 125 is powered off, the key icons 123 are transparent and cannot be seen by the users. The touch-type transparent keyboard 100 that is powered on is shown in FIG. 3.

The touch-type transparent keyboard 100 is a touch screen with a built-in keyboard layer 12. The touch-type transparent keyboard 100 is thin without additional support substrate for providing key icons. The key icons 123 of the keyboard layer 12 can be illuminated under the control of the control module 18, so the user can conveniently use the touch-type transparent keyboard 100 in dark or dim lighting conditions.

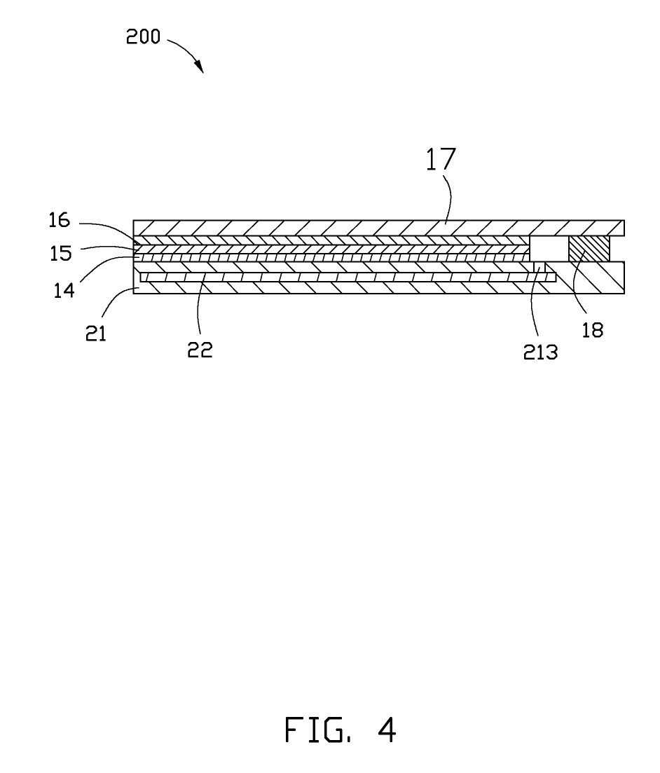

Referring to FIG. 4, a touch-type transparent keyboard 200 according to a second embodiment of the present disclosure is shown. The touch-type transparent keyboard 200 is similar to the touch-type transparent keyboard 100, differing in that a keyboard layer 22 is located in a transparent substrate 21, the transparent substrate 21 defines a hole 213, and the first insulation layer 13 of the first embodiment is omitted. The keyboard layer 22 is electronically connected to the control module 18 through the hole 213. The transparent substrate 21 may define a receiving groove (not labeled) to receive the keyboard layer 22.

In another exemplary embodiment, the position detection layer 16 may be a resistive layer and made of transparent conductive materials, such as ITO, aluminum-doped zinc oxide, or CdO.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A touch-type transparent keyboard, comprising:
a transparent substrate;
a keyboard layer;
a first insulation layer;
a shield layer;
a second insulation layer;
a position detection layer;
a transparent protective layer; and
a control module;
wherein the keyboard layer and the control module are located on the transparent substrate, the first insulation layer is attached to the keyboard layer, the shield layer is located between the first insulation layer and the second insulation layer, the position detection layer is located between the second insulation layer and the protective layer; the keyboard layer, the shield layer and the position detection layer are electronically connected to the control module.

2. The touch-type transparent keyboard as claimed in claim 1, wherein the control module includes a ground terminal, the shield layer is electronically connected to the ground terminal.

3. The touch-type transparent keyboard as claimed in claim 2, wherein the keyboard layer includes a transparent film, a number of key icons, and a drive circuit; the key icons and the drive circuit are located on the film, the drive circuit is electronically connected to the key icons and the control module.

4. The touch-type transparent keyboard as claimed in claim 3, wherein the key icons are made of transparent electroluminescence material, when the drive circuit is powered on, the key icons illuminate.

5. The touch-type transparent keyboard as claimed in claim 4, wherein the position detection layer is a capacitive layer to detect touch locations.

6. The touch-type transparent keyboard as claimed in claim 4, wherein the position detection layer is a resistive layer to detect touch locations.

7. A touch-type transparent keyboard, comprising:
a transparent substrate;
a keyboard layer;
a shield layer;
an insulation layer;
a position detection layer;
a transparent protective layer; and
a control module;
wherein the keyboard layer is located in the transparent substrate, the shield layer is located on the transparent substrate, the insulation layer is located between the shield layer and the position detection layer, the transparent protective layer is located on the position detection layer, the control module is located on the transparent substrate; the keyboard layer, the shield layer and the position detection layer are electronically connected to the control module.

8. The touch-type transparent keyboard as claimed in claim 7, wherein the control module includes a ground terminal, the shield layer is electronically connected to the ground terminal

9. The touch-type transparent keyboard as claimed in claim 8, wherein the keyboard layer includes a transparent film, a number of key icons, and a drive circuit; the key icons and the drive circuit are located on the film, the drive circuit is electronically connected to the key icons and the control module.

10. The touch-type transparent keyboard as claimed in claim 9, wherein the key icons are made of transparent electroluminescence material, when the drive circuit is powered on, the key icons illuminate.

11. The touch-type transparent keyboard as claimed in claim 10, wherein the transparent substrate defines a hole, the keyboard layer is electronically connected to the control module through the hole.

12. The touch-type transparent keyboard as claimed in claim 11, wherein the position detection layer is a capacitive layer to detect touch locations.

13. The touch-type transparent keyboard as claimed in claim 11, wherein the position detection layer is a resistive layer to detect touch locations.
